(19) United States
(12) Patent Application Publication
(10) Pub. No.: US 2014/0035511 A1
(43) Pub. Date: Feb. 6, 2014

(54) Battery Case for a Mobile Device

(71) Applicant: FKA DISTRIBUTING CO., LLC, Commerce Township, MI (US)

(72) Inventors: Roman S. Ferber, West Bloomfield, MI (US); Hing Wah Tsang, Ajax (CA)

(21) Appl. No.: 13/834,510

(22) Filed: Mar. 15, 2013

Related U.S. Application Data
(60) Provisional application No. 61/680,144, filed on Aug. 6, 2012.
(60) Provisional application No. 61/746,845, filed on Dec. 28, 2012.

(51) Int. Cl. H02J 7/00

(52) U.S. Cl. CPC H02J 7/0042
USPC 320/103

(57) ABSTRACT

A battery case for charging a mobile device received therein includes a housing having a back portion with a generally planar inner surface and an outer surface, and a side wall extending upwardly from the back portion. A battery is disposed within the housing, and a charging connector is stored within the housing in a stored configuration and in electrical communication with the battery. The charging connector includes a flexible tether having a proximal end connected to the housing and a distal end having an adaptor for mating with a connector of the mobile device. The charging connector has an outer surface and a lower surface, where the charging connector lower surface is bounded by a plane of a lower end of the battery case in the stored configuration.

### CROSS-REFERENCE TO RELATED APPLICATIONS

This application claims the benefit of U.S. provisional Application No. 61/680,144 filed Aug. 6, 2012 and U.S. provisional Application No. 61/746,845 filed Dec. 28, 2012, the disclosures of which are incorporated in their entirety by reference herein.

### TECHNICAL FIELD

Embodiments relate to a battery case for a mobile device.

### BACKGROUND

Electronic devices include mobile telephones, personal digital assistants, tablets, e-readers, laptops, cameras, portable navigation systems, personal digital music players, handheld game consoles, and the like. Some mobile devices have removable rechargeable batteries where the battery is placed into a docking station to be recharged, or alternatively is recharged while located within the device. Others have internal rechargeable batteries which are recharged while located within the device. As the devices are mobile, a need arises for a mobile or portable power source or charging device to permit charging of the device when remote from a wall outlet or other stationary power supply.

### SUMMARY

In one embodiment, a battery case for charging a mobile device received therein is provided including a housing having a back portion with a generally planar inner surface and an outer surface, and a side wall extending upwardly from the back portion. A battery is disposed within the housing, and a charging connector is stored within the housing in a stored configuration and is in electrical communication with the battery. The charging connector includes a flexible tether having a proximal end connected to the housing and a distal end having an adaptor for mating with a connector of the mobile device. The charging connector has an outer surface and a lower surface, where the charging connector lower surface is bounded by a plane of a lower end of the battery case in the stored configuration.

In another embodiment, a battery case for charging a mobile device received therein is provided including a housing having a back portion with a generally planar inner surface and an outer surface, and a side wall extending upwardly from the back portion and including a recessed portion at a lower end of the battery case. A battery is disposed within the housing, and a charging connector is stored within the housing in a stored configuration and is in electrical communication with the battery. The charging connector includes a flexible tether having a proximal end connected to the housing and a distal end having an adaptor for mating with a connector of the mobile device. The charging connector has an outer surface and a lower surface, where the charging connector outer surface is generally flush with the back portion outer surface and the charging connector lower surface is generally flush with the lower end of the battery case in the stored configuration.

In another embodiment, a two-piece battery case for charging a mobile device is provided which includes a shell portion having a generally planar support portion with a side wall extending upwardly from the support portion, the shell portion receiving the mobile device therein in a receiving state. A battery portion is releasably connected to the shell portion and has an outer surface, and a battery is disposed within the battery portion. A charging connector is stored within the battery portion in a stored configuration and is in electrical communication with the battery. The charging connector includes a flexible tether having a proximal end connected to the battery portion and a distal end having an adaptor for mating with a connector of the mobile device. The charging connector has an outer surface and a lower surface, where the charging connector lower surface is bounded by a plane of a lower end of the battery case in the stored configuration.

### BRIEF DESCRIPTION OF THE DRAWINGS

FIG. 1 is a front perspective view of a battery case for a mobile device with a charging connector in a stored configuration according to an embodiment;

FIG. 2 is a back view of the battery case of FIG. 1;

FIG. 3 is a side view of the battery case of FIG. 1;

FIG. 4 is a bottom view of the battery case of FIG. 1;

FIG. 5 is a front perspective view of a battery case for a mobile device with a charging connector in a deployed, charging configuration according to an embodiment;

FIGS. 6A and 6B are rear perspective views of the battery case holding a mobile device with a charging connector in a charging configuration engaging the mobile device and in a stored configuration, respectively, according to an embodiment;

FIGS. 7A and 7B are front perspective views of the battery case holding a mobile device with a charging connector in a stored configuration and in a charging configuration engaging the mobile device, respectively, according to an embodiment;

FIG. 8 is a side view of the battery case holding a mobile device with the charging connector in a charging configuration engaging the mobile device;

FIG. 9 is a front view of the battery case holding a mobile device with the charging connector in a charging configuration engaging the mobile device;

FIG. 10 is a bottom view of the battery case holding a mobile device with the charging connector in a charging configuration engaging the mobile device;

FIG. 11 is a side view of a battery case for a mobile device having an integrated onboard USB connector according to an embodiment;

FIG. 12 is a back view of a battery case for a mobile device having an integrated AC adapter according to an embodiment;

FIG. 13 is a back view of a battery case for a mobile device schematically illustrating audio notification features according to an embodiment; and

FIG. 14 is a rear perspective view of a two-piece battery case for a mobile device separated into a battery portion and a shell portion according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

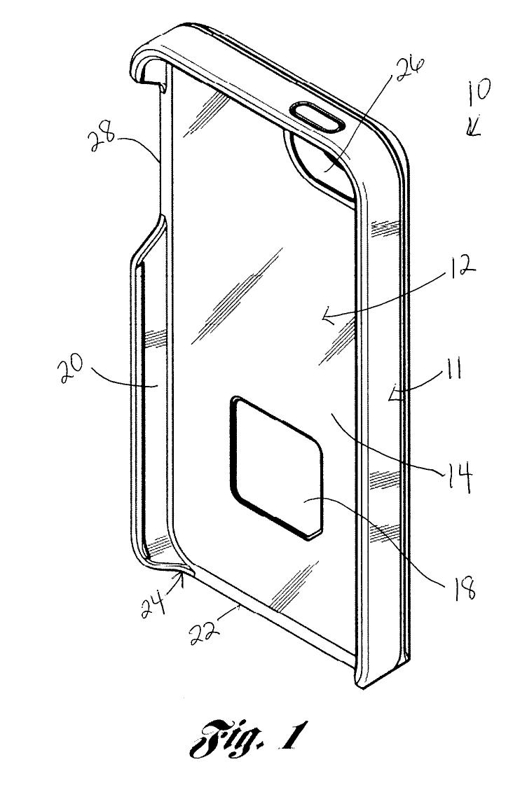

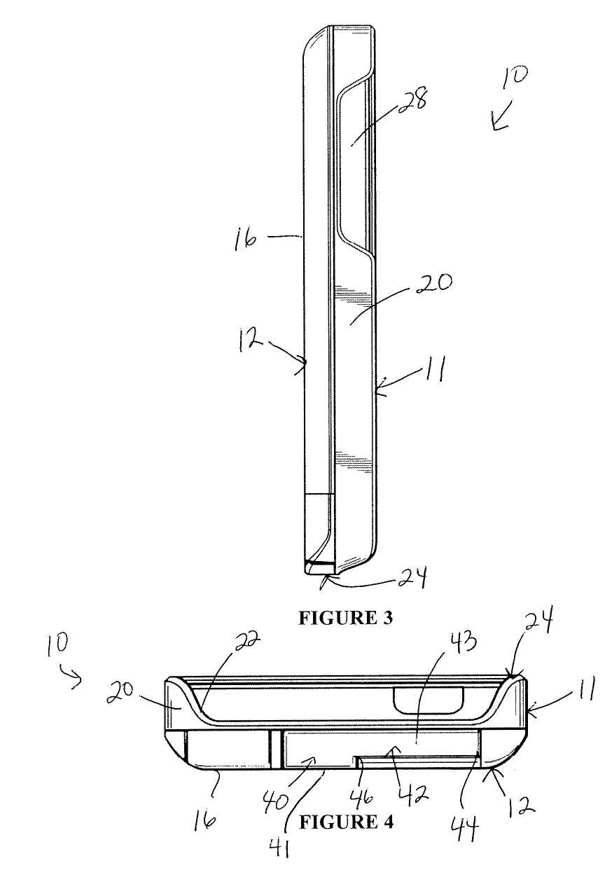

With reference first to FIGS. 1-4, a battery or charging case 10 for a mobile device is illustrated. In one embodiment, the battery case 10 is compatible with various models of an APPLE IPHONE, such as iPhone 5, but is not limited to this device or to cellular telephones. The battery case 10 may be used with a tablet or other mobile device. The battery case 10 includes a housing 11 with a back portion 12 having a generally planar inner surface 14 and an outer surface 16, the back portion 12 supporting a mobile device and housing a battery 18. The housing 11 further includes a side wall 20 extending upwardly from the back portion 12 and at least partially surrounding the back portion 12 with a sufficient depth to receive and retain the mobile device. The housing 11 may be constructed from any material such as, for example, metal or plastic, which provides sufficient structure for retaining the mobile device therein. In one embodiment, at least a portion of the side wall 20 may be constructed from a flexible material such as, but not limited to, rubber, for ease of insertion of the mobile device into the case 10. A grip surface (not shown) may be provided on an outer surface of portions of the side wall 20 for ease of handling of the case 10 by a user.

While the side wall 20 extends at least partially along the sides of the mobile device, in one embodiment the case 10 is configured such that the upper and/or lower ends of the mobile device remain uncovered and accessible. For example, a recessed portion 22 of the side wall 20 may be provided at a lower end 24 of the battery case 10 as shown, such that when a mobile device is received in the battery case 10, the battery case lower end 24 is generally co-planar with a lower end of the mobile device. The housing 11 may also include various apertures and ports to accommodate the features and functionalities of the mobile device. For example, the back portion 12 may include an opening 26 for the camera lens of the mobile device, and apertures or an open portion 28 of the side wall 20 may be provided to allow access to control buttons of the mobile device.

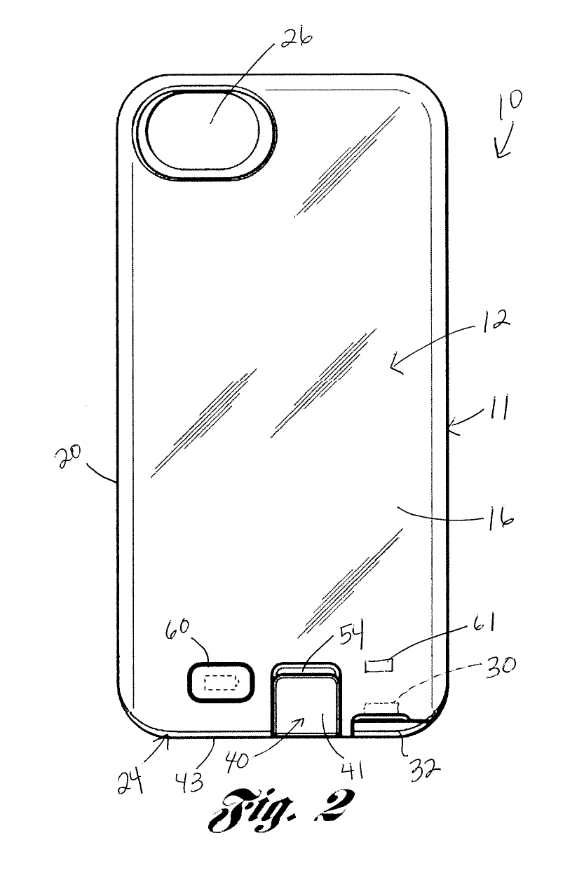

As described above, the battery case 10 includes a battery 18 for providing power to and charging the mobile device. In one embodiment, the battery 18 may be a 2000 mA battery, but other battery capacities are also contemplated. For example, the battery capacity may be designed to correspond to the battery capacity of the associated mobile device. The battery 18 may be a lithium ion, lithium polymer, or other rechargeable battery chemistry. The battery case 10 includes a port 30 (best shown in FIG. 2) for receiving an external power input to charge the battery 18 in a charging state, such as along the back portion outer surface 16 at a lower end 24 of the case 10. In one embodiment, the port 30 is configured to receive a micro USB cable, although other connector types and locations are also contemplated. A flexible flap 32, such as a rubber or silicone flap, may cover the port 30 when in a non-charging state. In one embodiment, the flap 32 may contain an embedded magnet which is magnetically attracted to metal in the housing 11 to retain the flap 32 over the port 30 using magnetic forces. The charging of the battery 18 may commence automatically following external input to the port 30, or may require user input, such as in the form of a switch (not shown).

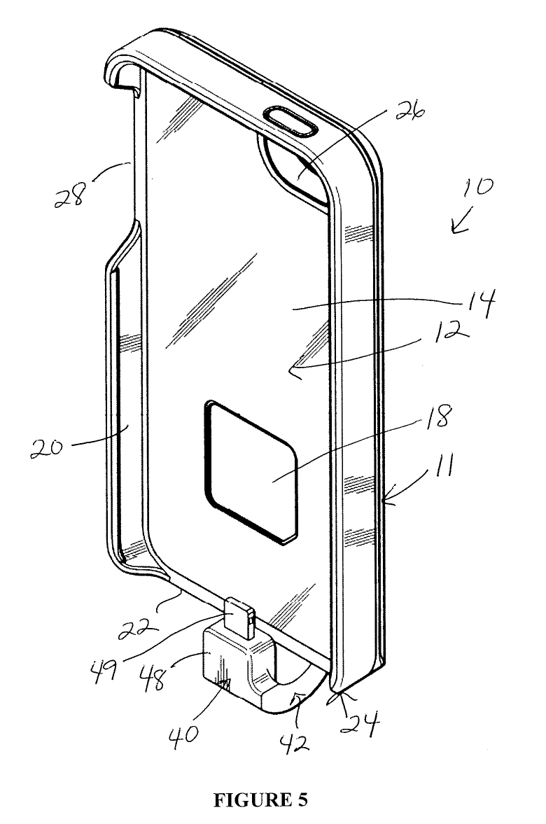

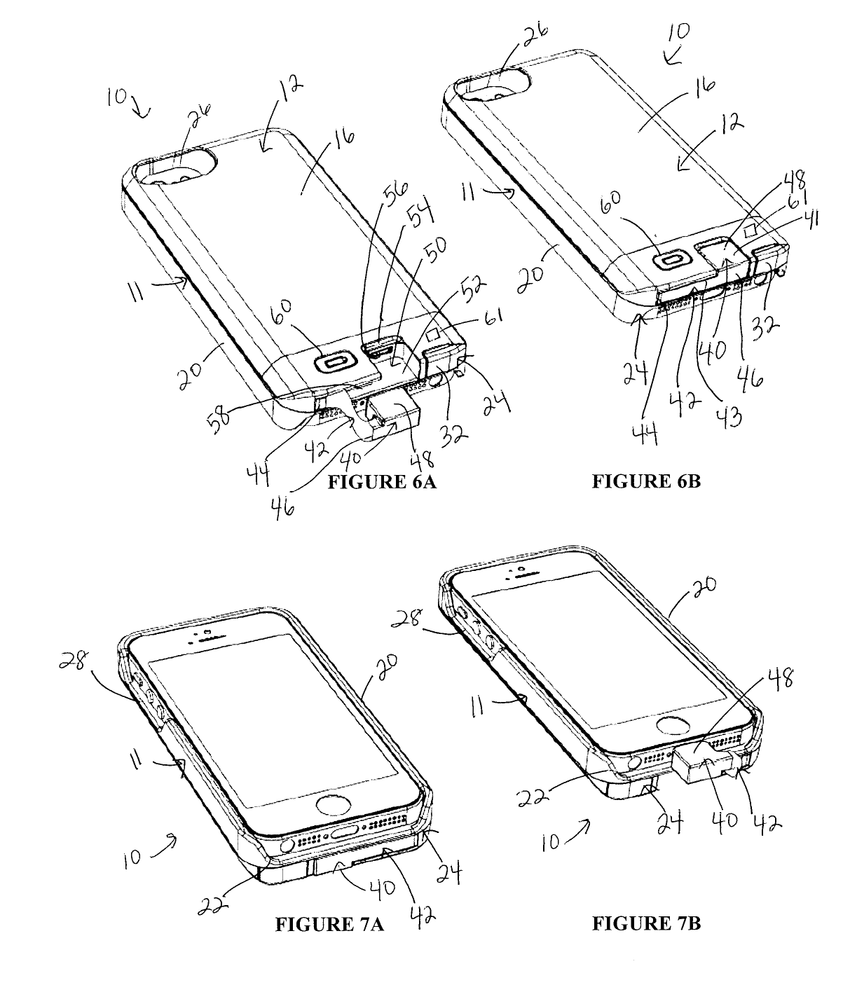

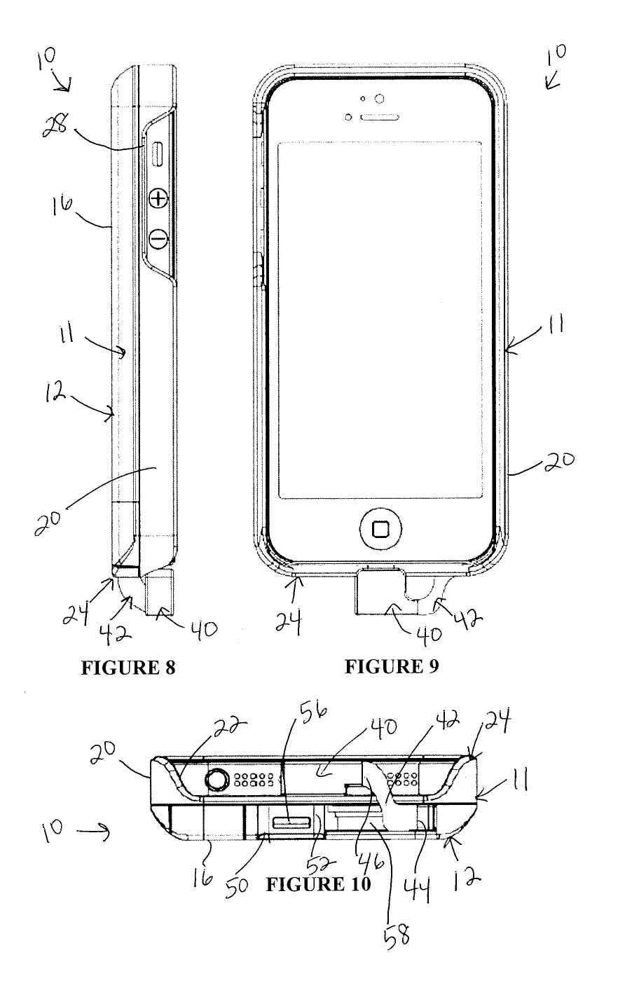

With reference to FIGS. 2, 4 and 5, and to FIGS. 6-10 which illustrate the case 10 holding a mobile device, the battery case 10 has a charging connector 40 for mating with and powering/charging the mobile device by providing power from the battery 18 contained within the case 10 to the battery on-board the mobile device. In one embodiment, the charging connector 40 includes a flexible cable or tether 42, such as a flat cord, allowing ease of alignment with the corresponding female connector on the mobile device for charging. The tether 42 has a proximal end 44 connected to the housing 11 and a distal end 46 with an adaptor 48 provided thereon. The charging connector 40 is in electrical communication with the battery 18 and power is provided from the battery 18 to the adaptor 48 via the flexible tether 42. The adaptor 48 may include an eight pin connector 49 (such as for an iPhone 5), a thirty pin connector, a micro- or mini-USB connector, or any other mobile device power connector. In one embodiment, the adaptor 48 may have a detent, ridge, or other feature (not shown) to aid the user in engaging and moving the connector 40 out of the stored configuration, as will be described further below.

As best shown in FIGS. 2, 4 and 6B, the charging connector 40 has an outer surface 41 and a lower surface 43. When not in use, the charging connector 40, including the tether 42 and adaptor 48, may be stored within the battery case 10 so that the charging connector outer surface 41 is bounded by a plane of the back portion outer surface 16, and that the charging connector lower surface 43 is bounded by a plane of the lower end 24 of the battery case 10, such that the charging connector 40 does not extend beyond a lower end of a mobile device received in the case 10. In one embodiment, the charging connector 40 may be generally flush with the back portion outer surface 16 and the lower end 24 of the battery case 10 in the stored configuration. However, the charging connector 40 may have any location on the battery case 10 suitable for mating with the connector of a particular mobile device.

As best shown in FIGS. 6A and 10, the charging connector 40 may be configured to fit into a corresponding recessed area 50 within the housing 11. In one embodiment, the recessed area 50 includes a storage portion 52 for receiving the adaptor 48, wherein the storage portion 52 may have a depth such that the adaptor 48 is generally flush with the back portion outer surface 16 when stored. The storage portion 52 may include a ledge 54 (also shown in FIG. 2) which provides a gap between the back portion outer surface 16 and the adaptor 48 when stored to facilitate accessing and dislodging the charging connector 40 in order to move it into a charging configuration as described below. The storage portion 52 may also include an internal slot 56 for receiving the pin connector 49 when the charging connector 40 is in the stored configuration. The recessed area 50 further includes a groove or channel 58 for receiving the cable or tether 42 for storage of the charging connector 40. In one embodiment, the channel 58 has a depth such that the tether 42 is generally flush with the lower end 24 of the battery case 10 when the charging connector 40 is in the stored configuration. Alternatively, the storage area 52 and channel 58 may be sized such that the adaptor 48 and tether 42 are disposed inward of the back portion outer surface 16 and/or lower end 24, respectively, when stored. The charging connector 40 may be retained in the stored configuration using detents or other friction retention mechanisms.

When the mobile device is to be charged, the charging connector 40 can be dislodged from the recessed area 50 and the plane of the battery case 10, while remaining connected to the case 10 via the flexible tether 42, and the charging connector 40 moved into the plane of the mobile device into a charging configuration (FIGS. 6A and 7B) so that the adaptor 48 is aligned for insertion into the corresponding female connector on the mobile device. The charging connector 40 may be retained in the charging configuration by detents and/or the friction between the adaptor 48 and the mobile device connector. In one embodiment, the integrated and nested charging connector 40 does not extend beyond a lower end 24 of the battery case 10, nor beyond a lower end of the received mobile device, until deployed into the charging configuration, allowing the mobile device to be docked and allowing full accessibility to the audio ports (e.g., headphone jack) and connectors on the lower end of the mobile device without having to remove the battery case 10.

With reference to FIGS. 2 and 6A-6B, the battery case 10 may include a battery level check button 60, such as on the back portion outer surface 16, that is operably connected to the battery 18 and that can be depressed to indicate the level of charge of the battery 18. In one embodiment, the button 60 may glow green if the battery is 66%-100% charged, may glow yellow if the battery is 33%-65% charged, and may glow red if the battery is 10%-32% charged. Alternatively, a light or series of lights, such as light emitting diodes (LEDs) may be provided which indicate the level of battery charge either by different colors as described above or via a number of LEDs illuminated, either automatically or in response to user input. Other indicators of the level of charge of the battery 18 are also contemplated.

As depicted in FIGS. 6A, 6B, 7A and 7B, in order to charge a mobile device within the battery case 10, the charging connector 40 may first be moved out of the stored configuration, for example, by sliding the connector in a first direction. Some amount of retention force may be present that the user needs to overcome to move the connector 40. Once the charging connector 40 is removed from its stored configuration within the battery case 10, the user may then move the charging connector 40 in a second direction and into the plane of the mobile device to align the adaptor 48 with the connector of the mobile device. The charging connector 40 moves in the second direction through movement of the flexible cable or tether 42. The charging connector 40 is then connected to the mobile device by the user moving the charging connector 40 in a third direction such that the adaptor 48 mates with the mobile device connector. Upon the charging connector 40 engaging the mobile device connector, powering/charging of the mobile device battery can commence automatically, or can require the activation of a user input, such as a switch 61, to begin the charging process (see FIGS. 2, 6A and 6B). In one embodiment, the first and third directions of motion of the charging connector 40 are along generally parallel and spaced apart axes. In order to move the charging connector 40 from the charging configuration to the stored configuration, the charging connector 40 is moved by the user in a reverse order of the steps described above.

Under circumstances where the charging connector 40 is engaged with the mobile device connector for charging while an external power input is provided to the port 30, the battery 18 of the battery case 10 may be charged first and then, upon completion of charging of the battery 18, the battery on-board the mobile device may be charged second. Alternatively, the external power input to the port 30 may be passed through to power and charge the battery on-board the mobile device first and, when completed, may be followed by charging of the battery 18 in the battery case 10. As still a further alternative, an external power input to the port 30 with the charging connector 40 connected to the mobile device connector may result in simultaneous charging of the battery 18 of the case 10 and the battery on-board the mobile device.

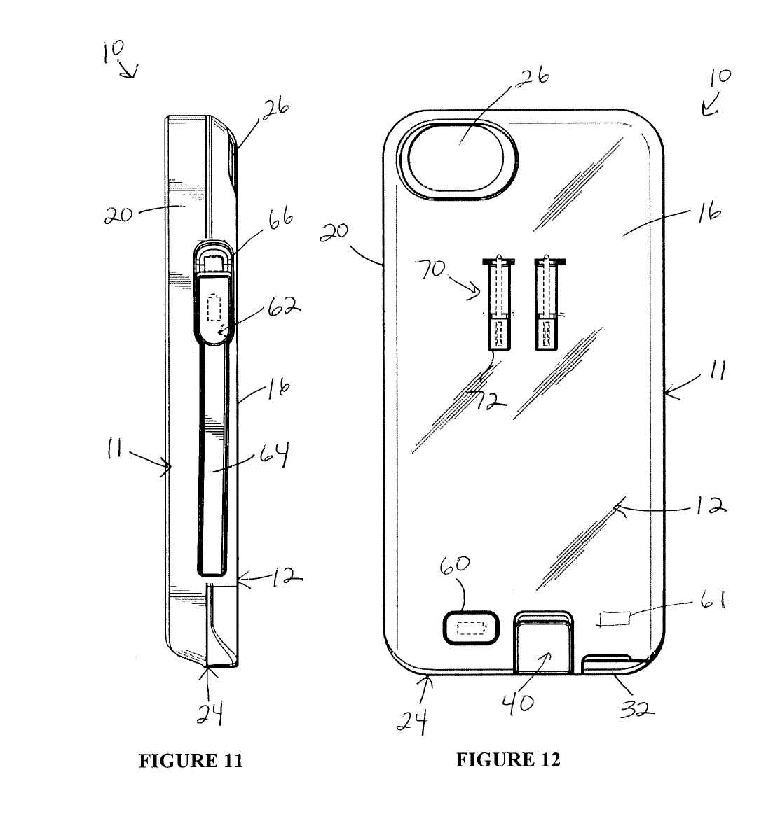

In one embodiment illustrated in FIG. 11, the housing 11 of the battery case 10 may include an integrated onboard USB connector 62 for recharging the battery 18 contained within the case 10, although other connector types are also contemplated. The USB connector 62 may be attached to a flexible cable 64 and can nest within the housing 11 when not in use. The USB connector 62 may be in electrical communication with the battery 18 and may be used to charge the battery 18 using an outside power source. The cable 64 may wrap around a portion of the housing 11, and may fit into a respective groove or channel 66 designed within the housing 11. The channel 66 may be sized such that the connector 62 is retained within the channel 66 by friction when not in use.

In another embodiment shown in FIG. 12, the battery case 10 may include an integrated folding or flip out alternating current (AC) adaptor 70. The AC adaptor 70 is in electrical communication with the battery 18 and allows the battery case 10 to be connected to a wall outlet to charge the battery 18 in the case 10 and/or provide pass-through charging to any connected electronic devices. Any AC adaptor for use with 100-240 VAC is contemplated for use with the battery case 10. The housing 11 may have a recessed area 72 for the prongs of the AC adaptor 70 to fold into when not in use.

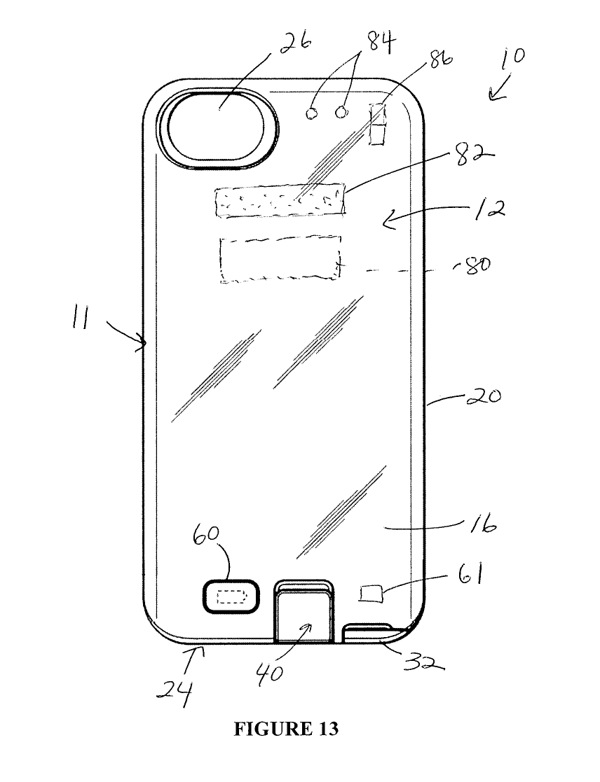

As depicted in FIG. 13, an audio notification module 80 may be incorporated into the battery case 10 and operably connected to the battery 18 for providing an audio indication, such as a tone or series of tones, a voice statement, or a combination of the two, in response to different powering and charging events. The audio notification module 80 may include a speaker 82 to audibly broadcast the notification. Such an audio notification not only provides the user with an indication of the specific type of device being charged, but also serves as a vehicle for advertising the services of others. In addition, the tones or voice prompts could be user-selectable either through stored customizable sounds, or downloaded or wirelessly transmitted to the battery case 10 by a user. In one embodiment, the mobile device begins charging only after all audio notification by the battery case 10 is complete so that the mobile device sounds do not interfere with the information being conveyed by the battery case 10. Different languages, accents, or gender may be selected for voice scripts. The audio notification feature may be switched on and off by a user, such as via engagement of a tool with a micro hole (not shown) on the battery case 10. A portion of the audio notification may be switched off, such that the tones are on and the voice scripts are off, or vice versa. Notification lights 84 may be provided to indicate to the user whether the tones and/or the voice notifications are on. A volume selection input 86 may be provided to increase, decrease, or mute the audio notifications.

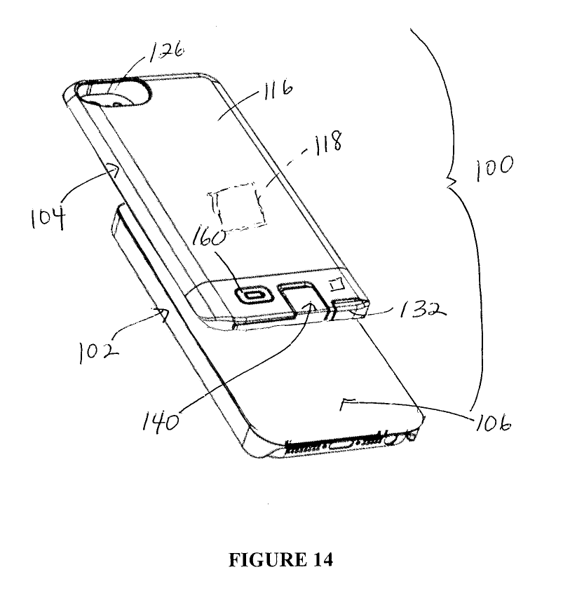

With reference to FIG. 14, a two-piece battery case 100 is illustrated, wherein features that correspond to those of battery case 10 are provided with like reference numerals with the addition of a “1” prefix. The battery case 100 includes a shell portion 102 which can mate with a battery portion 104 having a battery 118 and a charging connector 140 for mating with and charging the mobile device. The shell portion 104 includes the side wall 120 which extend upwardly from a generally planar support portion 106, and the battery portion 104 includes the outer surface 116. The shell portion 102 and battery portion 104 are releasably connected, such as with a sliding detent mechanism or via actuation of a release button (not shown). The two-piece battery case 100 allows a user to add or remove the battery portion 104 when needed while protecting mobile device with the shell portion 102 of the battery case 100 regardless of whether the battery portion 104 is being used. The components and features described above with reference to battery case 10 may be equally applicable to two-piece battery case 100.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A battery case for charging a mobile device received therein, comprising:
a housing including a back portion having a generally planar inner surface and an outer surface, and a side wall extending upwardly from the back portion;
a battery disposed within the housing; and
a charging connector stored within the housing in a stored configuration and in electrical communication with the battery, the charging connector including a flexible tether having a proximal end connected to the housing and a distal end having an adaptor for mating with a connector of the mobile device, the charging connector having an outer surface and a lower surface, the charging connector lower surface bounded by a plane of a lower end of the battery case in the stored configuration.

2. The case of claim 1, wherein the charging connector outer surface is bounded by a plane of the back portion outer surface in the stored configuration.

3. The case of claim 1, wherein the side wall has a recessed portion at the lower end of the battery case.

4. The case of claim 1, wherein the housing includes a port receiving an external power input for charging the battery in a charging state.

5. The case of claim 4, wherein the port is a micro-USB port.

6. The case of claim 4, further comprising a flexible flap covering the port when in a non-charging state.

7. The case of claim 1, wherein the housing includes a recessed area receiving the charging connector in the stored configuration and including a storage portion receiving the adaptor and a channel receiving the tether.

8. The case of claim 7, wherein the storage portion includes a ledge which provides a gap between the back portion outer surface and the adaptor when the adaptor is received in the storage portion.

9. The case of claim 1, wherein the housing includes a battery check button operably connected to the battery for indicating a level of charge of the battery.

10. The case of claim 1, further comprising an integrated USB connector in electrical communication with the battery for recharging the battery, the connector having a flexible cable configured to nest within the housing.

11. The case of claim 1, further comprising an integrated AC adaptor in electrical communication with the battery for charging the battery.

12. The case of claim 1, further comprising an audio notification module operably connected to the battery for providing an audio indication in response to powering and charging events of the battery case.

13. A battery case for charging a mobile device received therein, comprising:
a housing including a back portion having a generally planar inner surface and an outer surface, and a side wall extending upwardly from the back portion and including a recessed portion at a lower end of the battery case;
a battery disposed within the housing; and
a charging connector stored within the housing in a stored configuration and in electrical communication with the battery, the charging connector including a flexible tether having a proximal end connected to the housing and a distal end having an adaptor for mating with a connector of the mobile device, the charging connector having an outer surface and a lower surface, the charging connector outer surface generally flush with the back portion outer surface and the charging connector lower surface generally flush with the lower end of the battery case in the stored configuration.

14. A two-piece battery case for charging a mobile device, comprising:
a shell portion having a generally planar support portion with a side wall extending upwardly from the support portion, the shell portion receiving the mobile device therein in a receiving state;
a battery portion releasably connected to the shell portion and having an outer surface;
a battery disposed within the battery portion; and
a charging connector stored within the battery portion in a stored configuration and in electrical communication with the battery, the charging connector including a flexible tether having a proximal end connected to the battery portion and a distal end having an adaptor for mating with a connector of the mobile device, the charging connector having an outer surface and a lower surface, the charging connector lower surface bounded by a plane of a lower end of the battery case in the stored configuration.

15. The case of claim 14, wherein the charging connector outer surface is bounded by a plane of the back portion outer surface in the stored configuration.

16. The case of claim 14, wherein the side wall has a recessed portion at the lower end of the battery case.

17. The case of claim 14, wherein the battery portion includes a port receiving an external power input for charging the battery in a charging state.

18. The case of claim 17, further comprising a flexible flap covering the port when in a non-charging state.

19. The case of claim 14, wherein the battery portion includes a recessed area receiving the charging connector in the stored configuration and including a storage portion receiving the adaptor and a channel receiving the tether.

20. The case of claim 14, wherein the battery portion includes a battery check button operably connected to the battery for indicating a level of charge of the battery.
